(19) United States
(12) Patent Application Publication
(10) Pub. No.: US 2001/0028363 A1
(43) Pub. Date: Oct. 11, 2001

(54) Method for receiving and managing electronic files and file-managing device used therefor

(75) Inventors: Junichi Nomoto, Tokyo (JP); Ryuichi Noshiro, Ichikawa-shi (JP); Akira Atsumi, Tokyo (JP); Masataka Yamamoto, Kitamoto-shi (JP); Kazuo Matsuda, Tokyo (JP)

Correspondence Address: Michael A. Jaffe, ARTER & HADDEN LLP, 1100 Huntington Building, 925 Euclid Avenue, Cleveland, OH, 44115-1475, US

(73) Assignee: Mitsubishi Corporation and Starnet Co., Ltd.

(21) Appl. No.: 09/740,395

(22) Filed: Dec. 19, 2000

(30) Foreign Application Priority Data
Apr. 10, 2000 (JP) 2000-108625
Sep. 26, 2000 (JP) 2000-292864

(51) Int. Cl. G06F 15/173; G06F 17/30

(52) U.S. Cl. 345/748; 345/853; 707/10; 707/527

(57) ABSTRACT

Provided is a file storing-and-managing method and device, for receiving, storing and managing electronic files over the Internet, the method and device including an effective and easy-to-operate GUI which can be operated visually and intuitionally without causing any stress. The file-managing device sends a graphical operation page to a user-computer connected over the Internet. The operation page includes a description (5) of the structure showing how the received-files are stored in the file-managing device and a description (7) of the structure showing how local files are stored in the user-computer, so that a user can easily upload and download files through graphical and intuitional operations of this page. Further, the file-managing device creates preview image data which is provided for previewing of the received-file and which has a data-size smaller than the original received-file. This preview image data is associated to and managed with the original received-file. When there is an instruction from the user where he wishes to preview a received-file, the file-managing device sends the preview image data to the user-computer instead of the whole received-file, and a small window (9) showing a preview image according to the preview image data is displayed on the user-computer.

### BACKGROUND OF THE INVENTION

The present application claims priority upon Japanese Patent Application No. 2000-108625 filed on Apr. 10, 2000, and Japanese Patent Application No. 2000-292864 filed on Sep. 26, 2000, which are herein incorporated by reference.

1. Field of the Invention

The present invention relates to a method for receiving electronic files over the Internet and storing and managing the files in an appropriate storage resource, and also to a file-managing device, which functions as a Web server on the Internet, to which such method is applied.

2. Description of the Related Art

There have been Web sites on the Internet which provide service such as receiving, storing and managing electronic files owned by individuals. In such a service, an individual become a member of the service by signing up through an online sing-up page, and then a predetermined amount of space in a storage resource is allocated to each member for storing his files. Then, a member accesses the Web server of the Web site using a Web browser installed in his computer, receives a Web page for operation, and uses this page for uploading a file stored in his computer to the storage resource of the Web server or for downloading a file stored in the storage resource to his computer.

For example, such a service can be used to save space in a hard disk of a user's computer. Storing and managing files in a Web server, rather than in a local hard disk, would be extremely beneficial especially for computers having a small amount of memory, such as PDAs, lap-top computers and mobile phones capable of accessing the Internet.

Further, such a service will enable a user to access his file anytime and anywhere over the Internet. For example, it would become possible for a user to share a file with a computer at his home and a computer in his office. Furthermore, files having been uploaded to the Web server will be securely maintained by the service-provider which provides the file receiving-and-managing service; that is, back-up files will be kept and virus checks will be conducted by the service-provider. Therefore, such a service is appropriate for managing important files.

In such a file receiving-and-managing service, since files which were managed by each individual are collected together and managed in one storage resource, considerable saving in resource and cost and efficient management of information resource such as hard disks can be realized. Therefore, it is expected that the demand for such a service will increase in the future as the network environment becomes more high-speed and inexpensive.

Meanwhile, there are cases in which the above-mentioned file receiving-and-managing service relies on a commercial base such as advertisement income. In such a case, customer acquisition is one important task in running the service. However, alike any other service on the Internet, it will not be possible to acquire permanent users if the mechanism of the service is complicated, or if the service is to force a user to conduct complicated operations, even if the service has superior features.

Particularly, in the file receiving-and-managing service, data management tends to become complicating and troublesome as the amount of files and folders created in the storage resource increases. In the meantime, local files and folders stored in a hard disk of the user's local computer must simultaneously be managed, which is also quite troublesome. Thus, in order to acquire many permanent users, it is important to provide a user-friendly operation environment which will enable a user to handle such files and folders intuitionally and visually.

Furthermore, in such a file receiving-and-managing service, files having a size much larger than contents handled by usual Web sites are frequently uploaded and downloaded. Uploading and downloading of such large files will take a lot of time and thus become irritating. Therefore, it is necessary to provide a stress-free operation environment in which a user can conduct an operation at ease, even at about 64 kbps, which is a communication speed used by an average PC user.

### SUMMARY OF THE INVENTION

It is an object of this invention to provide a method for receiving, storing and managing files, and a file-managing device used therefor which is provided with a user interface that can be operated intuitionally and visually and thus being user-friendly and stress-free, and which enables received-and-stored files to be shared among a plurality of users while maintaining security.

One aspect of a method of managing electronic files according to the present invention uses a file-managing device and at least one member computer mutually connected over the Internet. Here, the member computer is provided with a Web browser and is operated by a member. The file-managing device functions as a Web server, stores and manages a plurality of received-files entrusted and received from the member computer in an appropriate storage resource, and manages member verification information, such as member IDs and therewith associated passwords, and received-file location information respectively for each member. The method comprises the following steps: step 1 wherein the file-managing device verifies whether if the member computer accessing the file-managing device is authorized to access by using the above-mentioned member verification information, and sends file-operating-Web-data and an associated program to the member computer after verification; step A wherein the file-operating-Web-data and the associated program, which are sent to and working on the member computer, display a received file storage structure diagram (RFSS diagram), which is configured according to the above-mentioned received-file location information for the present member, on a display of the member computer; step B wherein the file-operating-Web-data and the associated program display a local file storage structure diagram (LFSS diagram) on the display of the member computer by checking an information structure of an external storage of the member computer; step C wherein, when a user of the member computer selects a certain file shown in the LFSS diagram, designates a folder shown in the RFSS diagram, and demands to upload the selected file to the designated folder, the file-operating-Web-data and the associated program read out the selected file from the external storage, and send the selected file to the file-managing device along with an instruction to store the selected file in the designated folder of the present member; step D wherein, when the user of the member computer selects a certain received-file in the RFSS diagram, designates a folder shown in the LFSS diagram, and demands to download the selected received-file to the designated folder, the file-operating-Web-data and the associated program send to the file-managing device a download instruction to send the selected received-file to the member computer; step 2 wherein, when the above-mentioned step C is executed, the file-managing device receives the selected file from the member computer, and stores the file in the designated folder of the present member; step 3 wherein, when the above-mentioned step D is executed, the file-managing device receives the download instruction, reads out the selected received-file from the storage, and sends the received-file to the member computer; step 4 wherein, along with the above-mentioned step 2, the file-managing device creates a preview image data based on the contents of the file received from the member computer; the preview image data expressed in a predetermined data format so that it has a data size smaller than the original file; step 5 wherein the file-managing device associates the preview image data to the original file and stores the preview image data in an appropriate storage resource; step E wherein, when the user of the member computer demands to view the contents of a specific file shown in the RFSS diagram, the file-operating-Web-data and the associated program send an instruction to the file-managing device to send the preview image data of the specified file to the member computer; step F wherein the file-operating-Web-data and the associated program receive the preview image data sent from the file-managing device, and display the contents of the preview image data on the display of the member computer; and step 6 wherein, when the above-mentioned step E is executed, the file-managing device receives the instruction to send the preview image data, reads out the preview image data for the specified file, and sends the data to the member computer.

According to another aspect of the present invention, the method of managing electronic files may further comprise: step G wherein, when the user of the member computer specifies a file in the RFSS diagram and demands to permit the specified file to be viewed by others, the file-operating-Web-data and the associated program, working on the member computer, send an instruction to the file-managing device to make the specified file viewable to others; step 7 wherein, when step G is executed and the instruction is received, the file-managing device creates in the storage resource a folder associated to a particular URL, copies the specified file and the thereto-associated preview image data to the folder, and informs the member computer of the URL over the Internet; and step 8 wherein the file-managing device receives, from an apparatus such as the member computer or any other computer through the Internet, a download-request to download a file or the thereto-associated preview image data stored in the folder located by the URL, and sends the requested file or the preview image data to the apparatus that sent the download-request.

According to another aspect of the present invention, the method of managing electronic files may further comprise: step 9 wherein, along with the execution of step 7, the file-managing device creates an access password when creating the folder associated to the URL, and associates the access password to the specified file; and step 10 wherein, along with the execution of step 8, the file-managing device receives a password string from the apparatus when receiving the download-instruction, matches the password string with the access password, and permits the specified file or the preview image data to be downloaded only when the password string has been verified as the correct password.

According to another aspect of the present invention, the method of managing electronic files may further comprise: step 11 wherein the file-managing device attaches a time-period-limiting information to the file copied to the folder at the URL, and permits downloading of the file only during the period of time determined by the time-period-limiting information.

According to another aspect of the present invention, the method of managing electronic files may further comprise: step 12 wherein the file-managing device receives, from the member computer over the Internet, a URL information concerning where a file desired to be downloaded is located, an information specifying a date-and-time at which the desired file is downloaded, and a folder-designation information concerning a designation of a folder existing in the storage resource to which the desired file is downloaded; and step 13 wherein, when the date-and-time according to the date-and-time information arrives, the file-managing device downloads through the Internet the desired file stored at the URL to the folder designated by the folder-designation information.

According to another aspect of the present invention, the file-managing device may manage a share folder, for each member, which is a folder for storing files that are viewable only to particular members, and the method may comprise: step H wherein, when the user of the member computer selects a file in the RFSS diagram and specifies another member to permit him to view the selected file, the file-operating-Web-data and the associated program working on the member computer send to the file-managing device a member-specifying-data for specifying the other member permitted to view the file; step 14 wherein, when the member-specifying-data is received upon execution of step H, the file-managing device associates the other member to the share folder; and step 15 wherein, when the above-mentioned step C is executed and an instruction to store a certain file in the share folder is received, the file-managing device stores the certain file in the share folder, and stores a copy of the certain file in an appropriate folder of the other member associated to the share folder.

According to another aspect of the present invention, the file-managing device may manage, for each member, at least one type-accorded folder for exclusively storing files having a particular file-type, and the method may comprise: step I wherein, when the user of the member computer selects a file in the LFSS diagram, and demands the selected file to be uploaded without designating a folder in the RFSS diagram, the file-operating-Web-data and the associated program working on the member computer make the member computer read out the selected file from the external storage, and send to the file-managing device an instruction to store the selected file in the appropriate type-accorded folder according to the file-type of the selected file; and step 16 wherein the file-managing device determines the file-type of the selected file sent according to the above-mentioned step I, and stores the file in the proper type-accorded folder according to its file-type.

According to another aspect of the present invention, the file-managing device may manage, for each member, at least one type-accorded folder for exclusively storing files having a particular file-type, and the method may comprise: step 17 wherein, when the above-mentioned step C is executed and an instruction to store a certain file in the share folder is received, the file-managing device stores the file in the share folder, and stores a copy of the file in a proper type-accorded folder of the other member associated to the share folder according to the file-type of the copied file.

According to another aspect of the present invention, the method of managing electronic files may comprise: step 19 wherein, when the above-mentioned process I is executed and there is sent an instruction to upload a file without designating a folder, or, when the file-managing device determines that there is no type-accorded folder associated to the file-type of a file sent along with an instruction to store the file in the share folder according to the above-mentioned step C, the file-managing device creates a new type-accorded folder associated to the file-type of the file, and stores the file in the new type-accorded folder.

According to another aspect of the present invention, the method of managing electronic files may comprise: step J wherein, when the user of the member computer creates a new folder in the RFSS diagram and demands to make the new folder a type-accorded folder by associating a file-type to the new folder, the file-operating-Web-data and the associated program working on the member computer send an instruction to create a new type-accorded folder to the file-managing device; and step 19 wherein the file-managing device creates a new type-accorded file for exclusively storing files having a particular file-type according to the instruction sent by execution of the above-mentioned step J.

According to another aspect of the present invention, the method of managing electronic files may comprise: step K wherein, when the user of the member computer creates a comment data having a particular format and demands to upload a file selected from the LFSS diagram along with the comment data, the file-operating-Web-data and the associated program working on the member computer send to the file-managing device the selected file read out from the external storage and the comment data; step L wherein, when the user of the member computer selects a file from the RFSS diagram and demands to view the contents of a comment of the selected file, the file-operating-Web-data and the associated program working on the member computer send an instruction to the file-managing device to send the comment data of the selected file to the member computer; step M wherein the file-operating-Web-data and the associated program working on the member computer receive the comment data sent from the file-managing device and display the contents of the comment on the display of the member computer; step 20 wherein the file-managing device receives the file sent by execution of the above-mentioned step K, associates the comment data to the file from which the comment data originated, and stores the comment data in an appropriate storage resource; and step 21 wherein, when the instruction to send the comment data of the selected file is received from the member computer or other member computers executing the above-mentioned step L, the file-managing device reads out the comment data and sends the comment data to the member computer or the other member computers which sent the instruction.

According to another aspect of the present invention, the method of managing electronic files may comprise: step N wherein, when the user of the member computer demands to associate the created comment data to a file designated in the RFSS diagram, the file-operating-Web-data and the associated program working on the member computer send to the file-managing device the comment data along with information for designating the file to which the comment data is associated; and step 22 wherein the file-managing device receives the comment data sent by execution of the above-mentioned step N, associates the comment data to the designated file, and stores the comment data in an appropriate storage resource.

Further, one aspect of a file-managing device according to the present invention is applicable to the above-mentioned method for managing electronic files.

### BRIEF DESCRIPTION OF THE DRAWINGS

For a more complete understanding of the present invention and the advantages thereof, reference is now made to the following description taken in conjunction with the accompanying drawings wherein:

FIG. 1 is a diagram showing a network structure in which a member computer and a file-managing device according to one embodiment of the present invention are connected;

FIG. 2 is a diagram showing an example of a displayed image of an operation page according to one embodiment of the present invention;

FIG. 3 describes an outline of a preview function according to one embodiment of the present invention, wherein

FIG. 3(A) is a flow chart showing a procedure in which a preview image data is created, and

FIG. 3(B) is a flow chart showing a procedure in which a preview image data is viewed;

FIG. 4 describes an outline of a function which enables other users to view a received-file according to one embodiment of the present invention, wherein

FIG. 4(A) is a flow chart describing a procedure for setting a URL where the file can be viewed, and

FIG. 4(B) is a flow chart describing a procedure for showing the file to others;

FIG. 5 describes a function enabling other members to view a received-file according to the “public method”, wherein

FIG. 5(A) is a flow chart describing a procedure for storing a file in a share folder, and

FIG. 5(B) is a flow chart describing a procedure for permitting view of the share folder; and

FIG. 6 describes a function enabling other members to view a received-file according to the “transferring method”, wherein

FIG. 6(A) is a flow chart describing a procedure for setting transferring conditions, and

FIG. 6(B) is a flow chart describing a procedure for permitting view of the transferred file.

### DETAILED DESCRIPTION OF THE INVENTION

One embodiment of a file-managing device and a file receiving-and-managing method mainly using the above device according to one embodiment of the present invention will be described below with reference to the attached drawings.

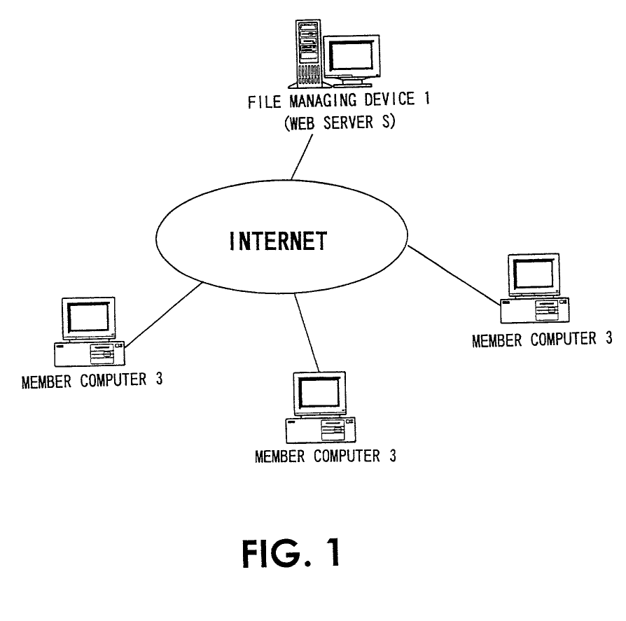

FIG. 1 is a diagram of an Internet-connected network including the file-managing device 1 according to one embodiment of the present invention. The file-managing device 1 is composed of one or a plurality of computers (such as personal computers, work stations or mainframes), and has basic functions of a Web server. The file-managing device 1 communicates with member computers 3 over the Internet, and provides service of receiving, storing and managing files. The member computers 3 are computers which are operated by members who have signed-up to obtain the file receiving-and-managing service, and are connected to the Internet. <<Sign-up Procedure>>

A person who wishes to obtain the file receiving-and-managing service provided by the file-managing device 1 must, in beforehand, sign-up as a member through a “sign-up Web page”. A Web page (hereinafter referred to merely as “page”) is a document or file written using languages such as HTML or XML which can be interpreted by Web browsers. The sign-up page is a free-access page opened to the public provided by the Web server function (or the Web server) of the file-managing device 1. When the file-managing device 1 receives a request from a computer to access to the URL of the sign-up page, the Web server sends the sign-up page back to that computer. The person who is operating the computer enters information, such as his individual information and password, to the sign-up page displayed on his computer, and sends the information back to the Web server through appropriate operation. Upon receipt of the information, the Web server creates a member ID for that person, and stores the information from that person (i.e., the individual information and password) in an appropriate storage device along with the member ID. (The information having been stored is hereinafter referred to as “member information”.) Then, the Web server sends a message to inform the person that he has been registered as a member of the service, and to inform him of his member ID. <<Storage Resource>>

The file-managing device 1 comprises a large-scale storage resource which is composed of external devices such as hard-disks and DVD-RAMs. The file-managing device 1 receives files from a member through the Internet (hereinafter referred to as “received-files”), classifies and stores the received-files in “folders” in the storage resource, and manages these files. In the present embodiment, a “file” is an entity of data recorded according to a certain rule, and has the same meaning as the term “file” used in MS-DOS (trademark) and UNIX (trademark). A “folder” is a location in which files and programs are stored, and has the same meaning as the term “directory” in MS-DOS and UNIX. It is possible to further create (or nest) another folder within one folder. Each of the files and folders stored and managed in the storage resource accompanies a file ID and folder ID, respectively. Further, a file accompanies a folder ID to which it is stored, and each file and folder accompanies a member ID. Furthermore, each received-file and folder accompanies attribute data such as file/folder name, the date in which the file/folder was created, date in which the file/folder was refreshed, data size and data type. The file-managing device 1 systematically manages the location information of the received-files of each member according to the IDs accompanying each file and folder.

<<Usage>>

When a member wants to use the storage resource, the member operates his member computer 3 to access a “utilization page” which is provided by the Web server. The Web server sends the utilization page back to the member computer 3. The member computer 3 displays the utilization page through the Web browser and encourages the user (i.e., member) to enter his member ID and password (hereinafter called “verification information”). Then, the verification information is sent back to the Web server. The Web server receives the verification information from the member computer 3, and checks the verification information against the above-described member information. If the person who sent the verification information is determined to be an authorized member, the Web server sends an “operation page” to the member computer 3.

An “operation page” accompanies an associated program and file operating Web data. The “associated program” is a program which can be executed in connection with a Web browser such as Java applet (trademark), JavaScript (trademark), Java Servlet (trademark), VBScript (trademark), CGI (trademark) and so forth. The “file operating Web data” is data created by the file-managing device 1 upon sending the operation page, and it includes the above-described location information regarding the received-files and folders of the member and the accompanying attribute data. The associated program and the file operating Web data realize the functions of the operation page.

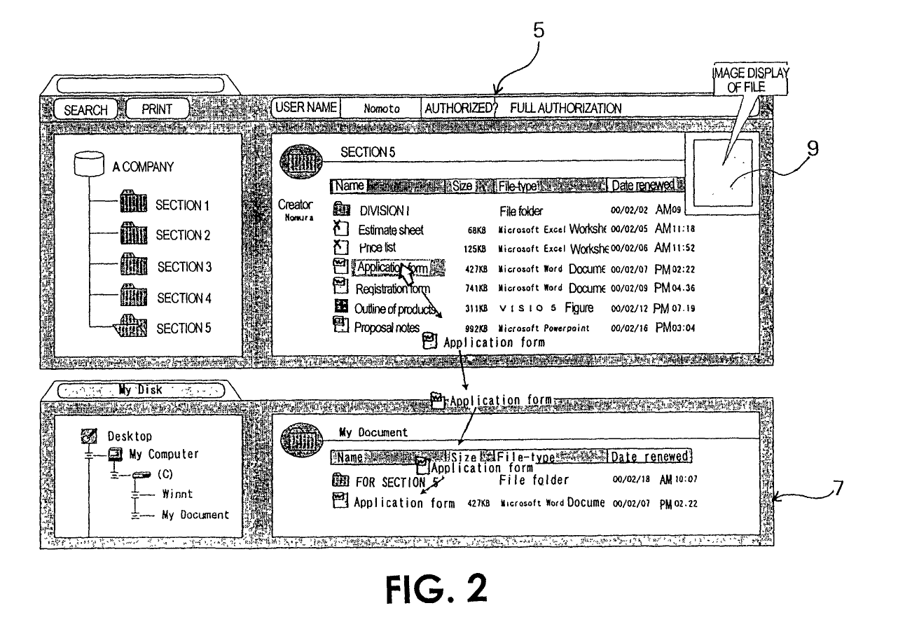

The member computer 3 receives the operation page and displays the operation page on its Web browser as shown in FIG. 2. As in FIG. 2, the operation page includes a “received-file storage structure diagram” 5 and a “local file storage structure diagram” 7. The received-file storage structure diagram 5 (hereinafter referred to as RFSS diagram 5) visually shows the state of the directory structure of the member's folders and received-files managed by the file-managing device 1. The local file storage structure diagram 7 (herein referred to as LFSS diagram 7) visually shows the state of the directory structure of the folders and files stored in an external storage drive, such as a hard disk, which is locally connected to the member computer 3. The file operating Web data and the accompanying program creates these diagrams 5 and 7.

Generally, in Web browsers and the accompanying program, there are provided access restrictions to files stored in the local hard disk in order to maintain security of the member computer 3. Because of these access restrictions, in some cases, it is not possible to create the LFSS diagram 7 just by using the basic functions of the Web browser and the associated program, since the associated program cannot access the local hard disk to recognize how the local files are stored. In this case, such an access restriction can be cleared by providing, for example, a mechanism in which the Web browser inquires an authorization center such as by VeriSign (trademark) to verify whether if the associated program is a safe program, and only after the verification has succeeded the associated program is allowed to read the information in the local hard disk.

<<Basic Function>>

The user of the member computer 3 operates the RFSS diagram 5 and the LFSS diagram 7 in order to execute operations such as to create, move, delete and rename files and folders through operations used in ordinary GUIs (Graphical User Interfaces). For example, the user may select a file or a folder from the RFSS diagram 5 or the LFSS diagram 7, right-click on the selected file/folder to display a menu list, and select an operation from the menu list. Here, an operation done against a certain file in the RFSS diagram 5 is sent to the file-managing device 1 as an operation instruction to accordingly operate the actual designated file in the storage resource over the Internet. The file-managing device 1 receives the operation instruction from the member computer 3, and actually operates the designated file stored in the storage resource according to the operation instruction. In executing this operation, the file-managing device 1 may specify the file or folder to be operated by using the member ID, folder ID and file ID accompanying the operation instruction.

In addition to these basic functions, the operation page is provided with various functions such as to upload files from the member computer 3 to the file-managing device 1, or to download files from the file-managing device 1 to the member computer 3.

<<Normal Upload Function>>

A normal upload function is such where a local file stored in an external storage device such as a hard disk of a member computer 3 is copied to the storage resource of the file-managing device 1. When uploading a local file, a user operates his mouse or keyboard, and drag & drops a certain file shown in the LFSS diagram 7 onto a folder shown in the RFSS diagram 5. The member computer 3 reads that file out from the external storage device, and sends this file to the file-managing device 1 along with an instruction to save the file in the designated folder. The associated program uses FTP (File Transfer Protocol) in executing this procedure. Upon receipt of the file and the accompanying instruction from the member computer 3, the file-managing device 1 locates the folder designated by the member ID and folder ID accompanying the instruction, and stores the received-file in that folder.

As can be appreciated, according to this file-managing device, it is possible to copy and upload a local file stored in a member computer 3 to the storage resource of the file-managing device 1 by conducting almost the same operation that would be performed in a standard GUI provided for a standard OS in a personal computer or work station, for example, as in File Manager (trademark) or Explorer (trademark) for Windows (trademark).

<<Uploading Using Automatic Classification>>

In the above-mentioned normal uploading function, a certain file designated in the LFSS diagram 7 is uploaded to a certain folder designated in the RFSS diagram 5. In addition to this normal uploading function, the file-managing device 1 is equipped with an “automatic classification uploading function”. With this function, the file-managing device 1 classifies a file, which has not been designated to a certain folder, to an appropriate folder according to its file-type, and the operation page is provided with functions to send appropriate instructions to the file-managing device 1 for executing the automatic classification uploading function.

A file having a specific type of file format is stored in a type-accorded folder previously provided in the file-managing device 1 for storing files having that specific file-type. Several type-accorded folders are provided for each of the file-types, and for example, text files, image files, or files created by typical word processor software or spreadsheet software are classified into their respective type-accorded folder.

When a file is uploaded without being designated to a certain folder, the file-managing device 1 classifies and stores the file to a certain type-accorded folder according to the data type included in the above-mentioned attribute data accompanying the uploaded file. For example, if the member computer 3 uses MS-DOS or Windows as its OS, the file-managing device 1 will classify the file according to its file name suffix such as “.doc”, “.xls”, “.jpg”, “.bmp”, “.gif”, “.txt” and so forth.

In some cases, a type-accorded folder for some types of files may not be provided. In order to cope with such a case, the operation page is provided with a function to create a new type-accorded folder. In the present embodiment, there is provided a “manual folder creation mode” in which the user creates the new folder, and an “automatic folder creation mode” in which the file-managing device automatically creates the new folder.

In the “manual folder creation mode”, the operation page creates a new folder, having a folder name appropriately named by the user, in the RFSS diagram 5. The newly created folder is associated with a specific file name suffix in order for a specific type of file to be stored therein. Then, an instruction to actually create the new type-accorded folder, along with information for corresponding a certain data type (or file-type) to the newly created folder, is sent to the file-managing device 1. The file-managing device 1 creates a new folder ID, and associates the member ID and data type to the folder ID.

On the other hand, in the “automatic folder creation mode”, when the file-managing device 1 recognizes that there is no type-accorded folder which corresponds to the data type of a received-file, the file-managing device 1 creates a new folder ID and attaches attribute data, such as folder name, to the folder by, for example, naming the folder according to the data type of the received-file. Also, the file-managing device 1 associates the ID of the newly created folder to the above-mentioned attribute data (such as data type) and member ID.

<<Download Function>>

A download function is such where a received-file stored in the storage resource of the file-managing device 1 is copied to the external storage device of the member computer 3. When the user drag & drops a file in the RFSS diagram 5 to a specific folder in the LFSS diagram 7, the member computer 3 sends an instruction to the file-managing device 1 to send the specified file to the member computer 3. Upon receipt of this instruction, the file-managing device 1 reads out the received-file specified by the member ID, folder ID and file ID sent along with the download instruction, and sends the file to the member computer by FTP. The member computer 3 receives the file from the file-managing device 1, and stores it in the specific folder designated by the drag & drop operation.

As can be appreciated, in this file-managing device, it is possible to copy and download a received-file stored in the file-managing device 1 to the member computer 3 by conducting almost the same operation that would be performed in a standard GUI provided for a standard OS in a personal computer or work station.

<<Preview Function>>

As the amount of files managed by the file-managing device 1 increase, it becomes difficult to identify a file only by its file name. In such a case, there arises a need to check the content of each and every file, since only the location information and attribute data, such as file name or data size, of the received-files are displayed in the above-mentioned operation page. In order to do so, the user (i.e., the member computer 3) must download the whole file from the file-managing device 1 by FTP and start an application software corresponding to the file each time the user wishes to take a look at the content of a received-file. If a high-speed communication line connects the file-managing device 1 and the member computer 3, there would be no problem in downloading the whole received-file. However, in a dial-up environment with a communication speed of about 64 kbps, it would take an extremely long time to download and view the content of a received-file. Further, it may become extremely irritating for a user particularly using small-sized computers or PDAs, since it takes a considerable amount of time to start an application software to view the downloaded file. In order to cope with such a problem and ease the stress burdened on the user, the file-managing device 1 is provided with a “preview function” where the content of a received-file can be viewed quickly.

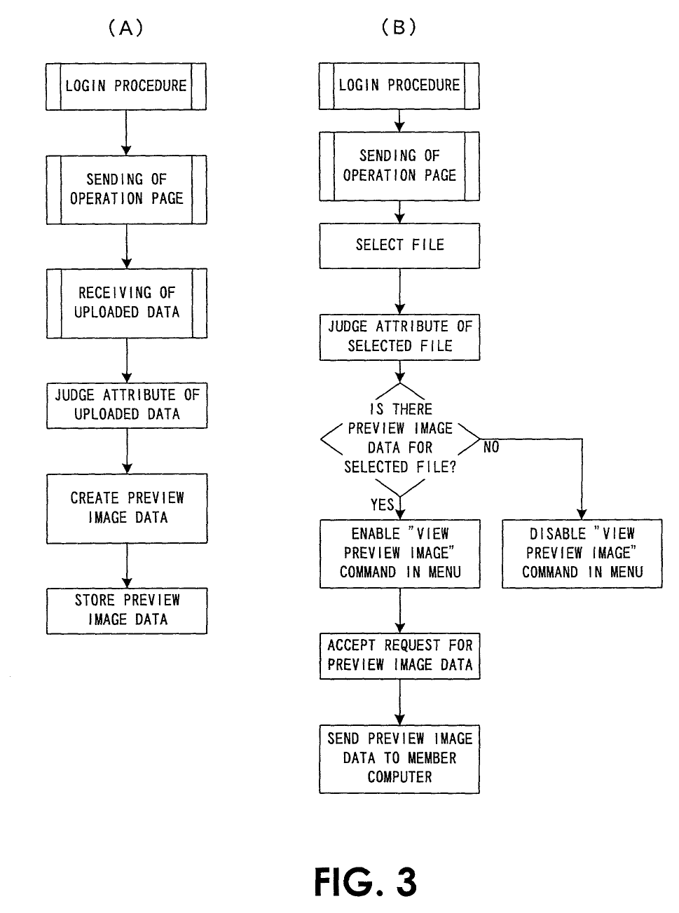

The preview function operates as follows: when the file-managing device 1 receives a file uploaded from a member computer 3, it creates a preview image data, having a predetermined file format and having a file size smaller than the original file, based on the received-file. This preview image data is downloaded instead of the original received-file when a user wants confirm the content of a file before downloading the whole file. For reference, FIG. 3(A) shows a flow chart of the procedure for creating a preview image data. FIG. 3(B) shows a flow chart showing the procedure for downloading a preview image data.

The preview image data may be in file types such as JPEG (Joint Photographic Experts Group) or GIF (Graphics Interchange Format), which have good compression rates. For example, if the original received-file is in BMP (BitMap File) format, the file-managing device 1 converts the file into GIF format to create a preview image data thereof. If the original received-file is a word-processor document or a text file, the file-managing device 1 subjects the received-file to bitmap development, and converts the bitmap image into an image file of a predetermined format to create a preview image data. In addition to the above-mentioned converting process, various processes, such as reduction in image size, subtraction of color, or reduction in pixel number, are conducted in order to make the data size of the preview image data smaller than the original received-file. The file-managing device 1 then associates the preview image data to the original received-file, and stores (saves) it in the storage resource.

For example, when the user points a mouse pointer 2 to a file information of a certain received-file shown in the RFSS diagram 5 displayed on his member computer 3, right-clicks to display a menu list, and selects the “preview” command from the list, the associated program sends, by FTP, an instruction to the file-managing device 1 to send the preview image data associated to the received-file selected in the RFSS diagram 5.

Upon receipt of the instruction from the member computer 3, the file-managing device 1 reads out the preview image data from the storage resource and sends it back to the member computer 3. The member computer 3 receives this preview image data, reproduces an image according to this data, creates a small window 9 on its display and displays the preview image in the small window 9.

By using this preview function, the user can easily view the content of a file. Since the data size of the preview image data is smaller than that of the original received-file, the amount of time required for downloading can be reduced, and thus, the preview function works extremely quickly. Therefore, the user can check the content of a file without feeling any stress during operation.

Above is an example in which the preview image data is downloaded to the member computer 3 when the user selects the “preview” command from the menu list. In order to further facilitate operation, the preview image data can be automatically downloaded to the member computer 3 and displayed when the mouse pointer 2 is pointed to a specific file in the RFSS diagram 5. Further, in order to provide a more user-friendly operation environment, the present invention may have a configuration such that if there already exists a preview image data downloaded to the hard disk of the member computer 3, the same data is not downloaded again.

<<Comment Attaching Function>>

The above-described preview image data is suitable in the case where the original received-file is an image file, wherein the content thereof can be presented visually. However, if the original received-file is, for example, a word processor file or a text file, it would be easier to check its content by reading an abstract thereof rather than visually viewing the whole character string. Accordingly, the file-managing device 1 is also provided with a “comment attaching function”, other than the above-mentioned preview function. According to this function, a “comment data”, which is an abstract of the original file in text format, is attached to the original file, and the user downloads this comment data instead of the whole original file to check its contents.

The comment attaching function may be carried out as follows. First, the user points the mouse pointer 2 to a certain file shown in the operation page and right-clicks thereon to display the menu list. The user selects the “create a comment” command from the menu list. Accordingly, the associated program displays a small window for entering a comment sentence. Then the user enters a comment sentence in this window.

If the file selected by the user is a local file in the LFSS diagram 7, the associated program processes the comment sentence into comment data of an appropriate format, and sends an instruction to the file-managing device 1 to upload the selected file along with the comment data. If the selected file is a received-file in the RFSS diagram 5, the associated program converts the comment sentence into comment data, and sends an instruction to the file-managing device 1 to attach the comment data to the selected received-file. The file-managing device 1 receives the instruction and the comment data from the member computer 3, and associates the received comment data to either the uploaded file or the received-file, and stores (saves) the comment data in the storage resource along with the original file.

In order to view the comment data, the user points to a certain file in the RFSS diagram 5, and appropriately selects the “view the comment” command. An instruction is sent from the member computer 3 to the file-managing device 1 to send the selected comment data. Upon receipt of this instruction, the file-managing device 1 accordingly reads out the comment data from the storage resource, and sends the data back to the member computer 3. Having received the comment data, the member computer 3 creates a small window 9 and displays the contents (the sentence) of the comment data in the window.

The file-managing device 1 also has a function of changing the contents of the comment data already stored in the storage resource. In the same manner as the “view the comment” command, the user makes the member computer 3 display the comment data to be changed in the small window 9. When the user right-clicks in the small window, a menu list, including commands for the comment data and the small window, appears on the display. When the user selects the “change the comment” command from the menu list, the comment data shown in the window becomes changeable. After the user finishes changing the contents of the comment, the member computer 3 sends an instruction to the file-managing device 1 to upload the changed comment data. Accordingly, the file-managing device 1 associates the changed comment data to the corresponding original received-file and stores (saves) it in the storage resource.

<<Function for Permitting Received-Files to be Viewed>>

There are cases in which a user wants to let others view his file stored in the storage resource of the file-managing device 1. In order to cope with such a demand, the file-managing device 1 is provided with functions to show a received-file of one member to other non-member users over the Internet, or, to permit a member computer 3 operated by other members of the present service to access a received-file of one member. In the present embodiment, the file-managing device 1 is provided with a function to show a received-file not only to members of the present service, but also to any non-member users, and also a function to permit only members of the present service to view a received-file.

<<Function for Showing Received File to Others>>

When the user desires to use the function to show his uploaded file to others (including both members and non-members), the user clicks and selects the desired file shown in the operation page, right-clicks to display the menu list, and selects the “show others” command from the menu list. Accordingly, the member computer 3 sends an instruction to the file-managing device 1 to make that file a “viewable object” which can be viewed by others. Upon receipt of this instruction, the file-managing device 1 creates an appropriate URL in the storage resource, makes a folder associated to the URL, copies the designated file and the thereto-associated preview image data (or comment data) to that folder, and sends back, to the member computer 3, a notification page informing the URL of the folder.

The member computer 3 receives this notification page and displays it on its display. The user (i.e., member) informs the person to which he wants to show the file at the URL by e-mail or any other appropriate method. When the person informed of the URL sends a request to the file-managing device 1 to download either the received-file or the preview image data (or the comment data) stored in the folder at that URL, the file-managing device 1 sends that file or data in the folder to the computer which sent out the request. Accordingly, that person can view the received-file (or the preview image data or the comment data) through the Web browser on his computer, or, he can download the received-file to his computer by FTP.

When creating the URL, it is possible to attach time-period-limiting data to the received-file copied to the folder at the URL. By doing so, the file within the folder can be accessed or downloaded through the Internet only within a limited period of time defined by the time-period-limiting data, and after that time period expires, the file will not be accessible through the Internet.

Further, when creating the folder corresponding to the URL, it is possible to create an access password and associate this password to the received-file to be copied to the folder. By doing so, the file-managing device 1 will ask for a password string to be entered when it receives a request to download the received-file, match the password string with the access password, and permit the received-file or preview image data to be downloaded only when the password string is the correct access password.

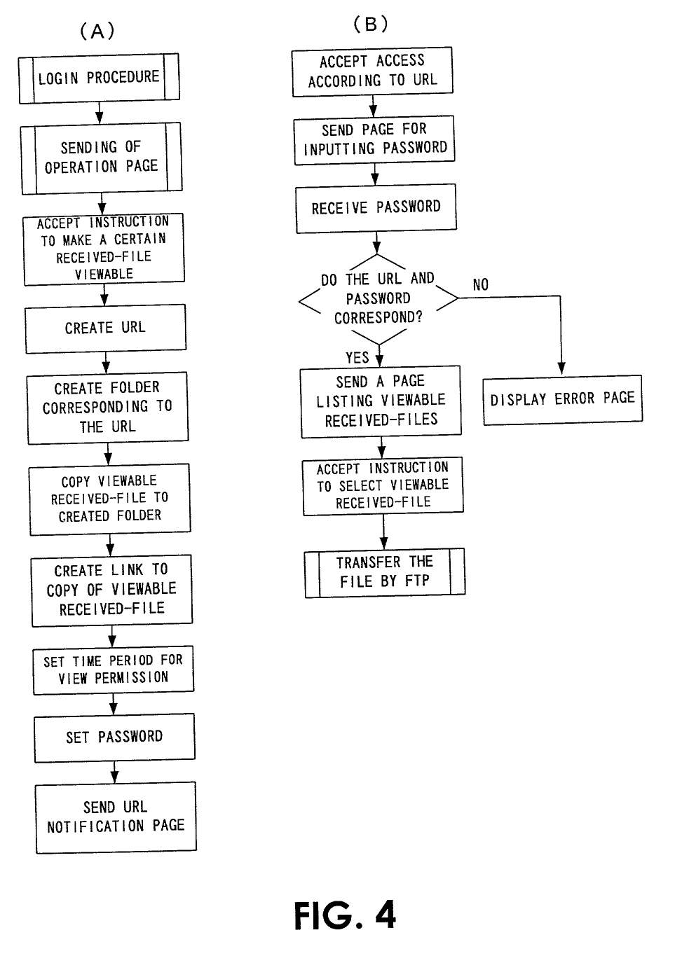

For reference, the outline of the actions of the file-managing device when functioning to show a received-file to others. FIG. 4(A) shows a flow chart describing the procedure for setting the URL of a viewable object file, and FIG. 4(B) shows a flow chart describing the procedure for showing the viewable object file to others.

<<Function for Showing Received File to Other Members>>

<Using Share Folder>

In order to permit only particular members of the present service to view (or download) received-files and its accompanying data (such as its preview image data and comment data) uploaded from a member computer, the file-managing device 1 can have a share folder for storing received-files which have been permitted for view among the particular members.

When a user (i.e., member) of a member computer 3 wishes to show a file displayed in the operation page to another member, the user selects the “create a share folder” command from the menu list. The member computer 3 sends an instruction to the file-managing device 1 to create a share folder. Upon receipt of this instruction, the file-managing device 1 creates a share folder for this particular member in an appropriate region of the storage resource. On the display of the member computer 3, the newly created share folder will be shown in the RFSS diagram 5. If the user wants to permit another member (hereinafter called “particular member”) to view the received-file within this share folder (hereinafter called “share file”), the user, for example, specifies the member ID of the particular member. The file-managing device 1 then associates the member ID to the ID of the share folder. When the user who created the share folder uploads, moves or copies a file within the LFSS diagram 7 or RFSS diagram 5 to the share folder, the file-managing device 1 stores that file in the share folder. When the share file is stored within the share folder, the file-managing device 1 transfers a copy of the share file to an appropriate folder of the particular member. Accordingly, a copy of the share file will appear in the appropriate folder in the RFSS diagram 5 of the operation page displayed on the member computer 3 (i.e., particular member computer 3) operated by the particular member. In one embodiment, the copy of the share file (hereinafter called “transferred file”) is classified and stored in a type-accorded folder of the particular member according to the file-type of the transferred file. In other embodiments, the transferred file can be stored in a root directory folder, or in a folder previously prepared for exclusively storing transferred files.

When there is a request from the above-mentioned particular member computer to download the share file or to download the various data attached to the original received-file (such as attribute data, preview image data, comment data), the file-managing device 1 sends out the appropriate data to the particular member computer. Here, a copy of the attached data can be created and transferred along with the transferred file, or, the transferred file may be associated to the attached data alike the share file.

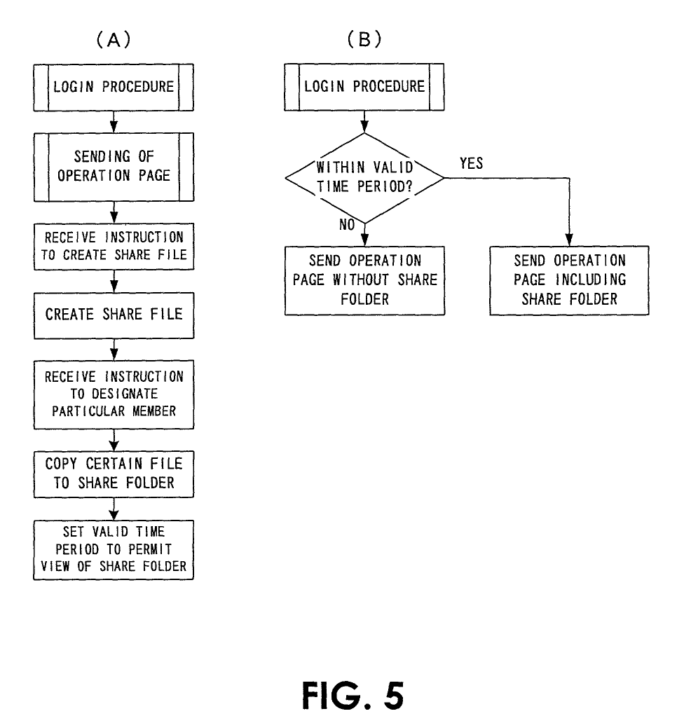

Instead of the above-mentioned method of transferring a copy of a share file, it is possible to adopt a “public method” in which the share folder is made public and accessible to the particular member according to the correspondence between the share folder ID and the particular member ID. In this case, a RFSS diagram 5 including the share folder will be displayed on the display of the particular member computer 3, and thereby the particular member can use the share file. In this method, it is possible for the user who created the share folder, or for the file-managing device 1 to attach a time-period-limiting data to the share folder, so that the particular member can access the share folder only during a limited period of time. Further, by making the file-managing device 1 send a copy of the share file to the particular member computer when there is a request to download a share file, it will be possible for the user who uploaded the share file and all other particular members to make further use of the original share file. FIGS. 5(A) and 5(B) explain this public method, wherein FIG. 5(A) is a flow chart showing the procedure for storing a file to a share folder, and FIG. 5(B) is a flow chart showing the procedure for showing the share file.

<File Transfer>

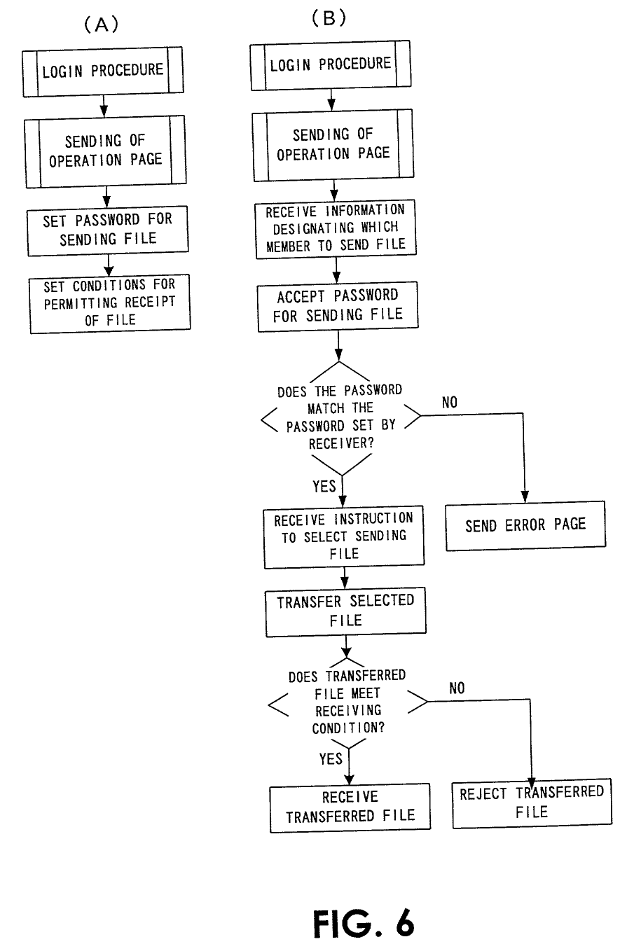

Apart from the above-mentioned method using a share folder, as another method of showing a file to a particular member, a “transferring method” shown in FIGS. 6(A) and 6(B) can be adopted. In this method, a member (“sender-member”) is to “send” his file to another member (“receiver-member”). As in FIG. 6(A), the receiver-member sets a password for allowing the sender-member to send a file, and the receiver-member informs the sender-member, which is another member allowed to send his file, of the password by e-mail or any other appropriate method. In this embodiment, the receiver-member can freely set conditions in receiving files; for example, the receiver-member can restrict files, having a certain data-type or sent from a certain sender, from being sent.

When the sender-member selects a received-file to be sent and enters the password of the receiver-member, the member computer 3 of the sender-member sends an instruction, along with the password, to the file-managing device 1 to transfer that file to the receiver-member. As in FIG. 6(B), the file-managing device 1 checks whether if the received password corresponds to the password of the receiver-member, and if the password is correct, it stores the file in an appropriate storage resource as a received-file of the receiver-member. Here, only transferred files meeting the previously set receiving conditions will be received (i.e., stored in the storage resource), even if it is a file sent from an authorized sender-member. When the receiver-member views the operation page, the file having been sent will be displayed in an appropriate folder in the RFSS diagram 5, and the receiver-member can make use of it.

<<Automatic Download Function>>

The file-managing device 1 is provided with a function to automatically download a file located at a specific URL to an appropriate folder in the storage resource at a predetermined time.

When using this function, the member computer 3 of a user (i.e., member) obtains a page from the above-mentioned Web server. The user enters information such as the URL of the file to be downloaded, the downloading date-and-time, and to which folder the file is to be downloaded. Then the member computer 3 sends this information to the file-managing device 1. A schedule program is running in the file-managing device 1, and when the file-managing device 1 receives the information from the member computer 3, it schedules downloading of the URL-specified file to be executed on the specified date-and-time and to the specified folder. When the specified date-and-time arrives, the schedule program downloads the file at the specified URL through the Internet to the member's specified folder.

Such a function becomes convenient in cases where a user wishes to download a file from a specific site on the Internet to his computer, but the communication line between his computer and the site is occupied taking an extremely long time for downloading. In such a case, the user can use the above-mentioned function, and download the desired file to his folder in the storage resource such as at midnight when the line is relatively vacant. The user then downloads the file to his computer from his folder in the storage resource to thereby smoothly obtain the desired file avoiding the occupied communication lines.

<<Options>>

<Opening Share Folder to Public>In the above-mentioned “Function for Showing Received Files to Other Members”, there was described a configuration in which the share folder is opened only to specific members. However, it is possible to open the share folder also to non-members. For example, the user can enter “not specified” instead of specifying a particular member ID in the above-mentioned procedure for creating a share file. Upon receipt of this information, the file-managing device 1 creates a Web page on the Internet to open the contents of the shared folder to the public. A hyperlink to this public-share-folder page can be provided on a Web page, such as the above-mentioned sign-up page, which can be freely accessed by general non-member client computers.

<Classification of Folder According to Function>

In the above-mentioned “Function for Showing Received Files to Other Members”, there may be individually provided in beforehand functional folders having particular functions, such as share folders for being opened to the public or share folders for transferring files. By doing so, the user will need only to associate a member ID of a member, to which access is permitted or to which a file is transferred, to the functional folder.

A functional folder which is used only for the “automatic download function” can be individually prepared in beforehand. A window or menu for entering the URL, file name, time schedule and folder name may automatically appear when a user points to this functional folder in the operation page.

According to the file receiving-and-managing method of the present invention, it is possible to provide a user with a visual, intuitional and user-friendly operational environment. Since the associated program and the file operating Web data, which realize such an operational environment, are fully provided by the Web server of the file-managing device, there is no need to provide special functions for the client machine other than a Web browser.

Further, since a preview image data, having a smaller data size than the original received-file, is downloaded instead of the whole received-file, the time required for downloading is reduced, and thus, it is possible to provide a stress-free, user-friendly operational environment.

In one aspect of the present invention, there is provided a configuration wherein: a certain received-file to be viewed by others is stored in a folder specified by a particular URL and an access password is associated to the folder; a request to download the received-file in that URL is received, along with a password string, through the Internet; and the received-file is sent over the Internet only when the received password string is certified as the correct access password. According to such a configuration, it becomes possible to share a certain received-file with others while sufficiently keeping security.

In one aspect of the present invention, there is provided a share folder enabling file exchange between members. When a member stores a file in his share folder, a copy of that file is stored in an appropriate folder of another particular member permitted to share that file. Accordingly, it becomes possible to let another particular member to use the share file as his own, without the need to inform the particular member of a URL of a share folder.

By providing type-accorded folders for respectively storing files having a specific file type, and automatically classifying and storing the uploaded files in the appropriate type-accorded folders according to its file type, the user does not have to designate a folder when uploading files. Further, file management becomes easy because it is possible to determine the type of files stored in a specific type-accorded file without checking the contents of each and every file. Further, by classifying and storing files having been transferred from other members in the type-accorded files, there will be no need for a troublesome operation of restoring and re-sorting the transferred files.

It is also possible to attach comment data to a received-file. When a user wants to check the contents of a received-file, either the preview image data or the comment data can be sent to the user according to the file-type of the original received-file. Therefore, it is possible for the user to precisely determine the contents of the received-file.

Although the preferred embodiment of the present invention has been described in detail, it should be understood that various changes, substitutions and alternations can be made therein without departing from spirit and scope of the inventions as defined by the appended claims.

What is claimed is:

1. A method of managing electronic files using a file-managing device and at least one member computer mutually connected over the Internet, wherein the member computer is provided with a Web browser and being operated by a member; and the file-managing device functions as a Web server, stores and manages a plurality of received-files entrusted and received from the member computer in an appropriate storage resource, and manages member verification information, such as member IDs and therewith associated passwords, and received-file location information respectively for each member;
the method comprising:
step 1 wherein the file-managing device verifies whether if the member computer accessing the file-managing device is authorized to access by using said member verification information, and sends file-operating-Web-data and an associated program to the member computer after verification;
step A wherein the file-operating-Web-data and the associated program, which are sent to and working on the member computer, display a received file storage structure diagram (RFSS diagram), which is configured according to said received-file location information for the present member, on a display of the member computer;
step B wherein the file-operating-Web-data and the associated program display a local file storage structure diagram (LFSS diagram) on the display of the member computer by checking an information structure of an external storage of the member computer;
step C wherein, when a user of the member computer selects a certain file shown in the LFSS diagram, designates a folder shown in the RFSS diagram, and demands to upload the selected file to the designated folder, the file-operating-Web-data and the associated program read out the selected file from the external storage, and send the selected file to the file-managing device along with an instruction to store the selected file in the designated folder of the present member;
step D wherein, when the user of the member computer selects a certain received-file in the RFSS diagram, designates a folder shown in the LFSS diagram, and demands to download the selected received-file to the designated folder, the file-operating-Web-data and the associated program send to the file-managing device a download instruction to send the selected received-file to the member computer;
step 2 wherein, when said step C is executed, the file-managing device receives the selected file from the member computer, and stores the file in the designated folder of the present member;
step 3 wherein, when said step D is executed, the file-managing device receives the download instruction, reads out the selected received-file from the storage, and sends the received-file to the member computer;
step 4 wherein, along with said step 2, the file-managing device creates a preview image data based on the contents of the file received from the member computer; the preview image data expressed in a predetermined data format so that it has a data size smaller than the original file;
step 5 wherein the file-managing device associates the preview image data to the original file and stores the preview image data in an appropriate storage resource;
step E wherein, when the user of the member computer demands to view the contents of a specific file shown in the RFSS diagram, the file-operating-Web-data and the associated program send an instruction to the file-managing device to send the preview image data of the specified file to the member computer;
step F wherein the file-operating-Web-data and the associated program receive the preview image data sent from the file-managing device, and display the contents of the preview image data on the display of the member computer; and
step 6 wherein, when said step E is executed, the file-managing device receives the instruction to send the preview image data, reads out the preview image data for the specified file, and sends the data to the member computer.

2. The method of managing electronic files according to claim 1 comprising:
step G wherein, when the user of the member computer specifies a file in the RFSS diagram and demands to permit the specified file to be viewed by others, the file-operating-Web-data and the associated program, working on the member computer, send an instruction to the file-managing device to make the specified file viewable to others;
step 7 wherein, when step G is executed and the instruction is received, the file-managing device creates in the storage resource a folder associated to a particular URL, copies the specified file and the thereto-associated preview image data to the folder, and informs the member computer of the URL over the Internet; and
step 8 wherein the file-managing device receives, from an apparatus such as the member computer or any other computer through the Internet, a download-request to download a file or the thereto-associated preview image data stored in the folder located by the URL, and sends the requested file or the preview image data to the apparatus that sent the download-request.

3. The method of managing electronic files according to claim 2 comprising:
step 9 wherein, along with the execution of step 7, the file-managing device creates an access password when creating the folder associated to the URL, and associates the access password to the specified file; and
step 10 wherein, along with the execution of step 8, the file-managing device receives a password string from the apparatus when receiving the download-instruction, matches the password string with the access password, and permits the specified file or the preview image data to be downloaded only when the password string has been verified as the correct password.

4. The method of managing electronic files according to claims 2 or 3 comprising:
step 11 wherein the file-managing device attaches a time-period-limiting information to the file copied to the folder at the URL, and permits downloading of the file only during the period of time determined by the time-period-limiting information.

5. The method of managing electronic files according to either one of claims 1-4 comprising:
step 12 wherein the file-managing device receives, from the member computer over the Internet, a URL information concerning where a file desired to be downloaded is located, an information specifying a date-and-time at which the desired file is downloaded, and a folder-designation information concerning a designation of a folder existing in the storage resource to which the desired file is downloaded; and
step 13 wherein, when the date-and-time according to the date-and-time information arrives, the file-managing device downloads through the Internet the desired file stored at the URL to the folder designated by the folder-designation information.

6. The method of managing electronic files according to either one of claims 1-5 wherein the file-managing device manages a share folder, for each member, which is a folder for storing files that are viewable only to particular members;
the method comprising:
step H wherein, when the user of the member computer selects a file in the RFSS diagram and specifies another member to permit him to view the selected file, the file-operating-Web-data and the associated program working on the member computer send to the file-managing device a member-specifying-data for specifying the other member permitted to view the file;
step 14 wherein, when the member-specifying-data is received upon execution of step H, the file-managing device associates the other member to the share folder; and
step 15 wherein, when said step C is executed and an instruction to store a certain file in the share folder is received, the file-managing device stores the certain file in the share folder, and stores a copy of the certain file in an appropriate folder of the other member associated to the share folder.

7. The method of managing electronic files according to either one of claims 1-5 wherein the file-managing device manages, for each member, at least one type-accorded folder for exclusively storing files having a particular file-type;
the method comprising:
step I wherein, when the user of the member computer selects a file in the LFSS diagram, and demands the selected file to be uploaded without designating a folder in the RFSS diagram, the file-operating-Web-data and the associated program working on the member computer make the member computer read out the selected file from the external storage, and send to the file-managing device an instruction to store the selected file in the appropriate type-accorded folder according to the file-type of the selected file; and
step 16 wherein the file-managing device determines the file-type of the selected file sent according to said step I, and stores the file in the proper type-accorded folder according to its file-type.

8. The method of managing electronic files according to claim 6 wherein the file-managing device manages, for each member, at least one type-accorded folder for exclusively storing files having a particular file-type;
the method comprising:
step 17 wherein, when said step C is executed and an instruction to store a certain file in the share folder is received, the file-managing device stores the file in the share folder, and stores a copy of the file in a proper type-accorded folder of the other member associated to the share folder according to the file-type of the copied file.

9. The method of managing electronic files according to claims 7 or 8 comprising:
step 19 wherein, when said process I is executed and there is sent an instruction to upload a file without designating a folder, or, when the file-managing device determines that there is no type-accorded folder associated to the file-type of a file sent along with an instruction to store the file in the share folder according to said step C, the file-managing device creates a new type-accorded folder associated to the file-type of the file, and stores the file in the new type-accorded folder.

10. The method of managing electronic files according to either one of claims 7-9 comprising:
step J wherein, when the user of the member computer creates a new folder in the RFSS diagram and demands to make the new folder a type-accorded folder by associating a file-type to the new folder, the file-operating-Web-data and the associated program working on the member computer send an instruction to create a new type-accorded folder to the file-managing device; and
step 19 wherein the file-managing device creates a new type-accorded file for exclusively storing files having a particular file-type according to the instruction sent by execution of said step J.

11. The method of managing electronic files according to either one of claims 1-10 comprising:
step K wherein, when the user of the member computer creates a comment data having a particular format and demands to upload a file selected from the LFSS diagram along with the comment data, the file-operating-Web-data and the associated program working on the member computer send to the file-managing device the selected file read out from the external storage and the comment data;
step L wherein, when the user of the member computer selects a file from the RFSS diagram and demands to view the contents of a comment of the selected file, the file-operating-Web-data and the associated program working on the member computer send an instruction to the file-managing device to send the comment data of the selected file to the member computer;
step M wherein the file-operating-Web-data and the associated program working on the member computer receive the comment data sent from the file-managing device and display the contents of the comment on the display of the member computer;
step 20 wherein the file-managing device receives the file sent by execution of said step K, associates the comment data to the file from which the comment data originated, and stores the comment data in an appropriate storage resource; and
step 21 wherein, when the instruction to send the comment data of the selected file is received from the member computer or other member computers executing said step L, the file-managing device reads out the comment data and sends the comment data to the member computer or the other member computers which sent the instruction.

12. The method of managing electronic files according to claim 11 comprising:
step N wherein, when the user of the member computer demands to associate the created comment data to a file designated in the RFSS diagram, the file-operating-Web-data and the associated program working on the member computer send to the file-managing device the comment data along with information for designating the file to which the comment data is associated; and
step 22 wherein the file-managing device receives the comment data sent by execution of said step N, associates the comment data to the designated file, and stores the comment data in an appropriate storage resource.

13. A file-managing device applicable to the method for managing electronic files according to either one of claims 1-12.
